(19) United States
(12) Patent Application Publication
(10) Pub. No.: US 2024/0273120 A1
(43) Pub. Date: Aug. 15, 2024

(54) AUTOMATIC DATA SOURCE MARKING USING AUTONOMOUS SYSTEMS

(71) Applicant: Intel Corporation, Santa Clara, CA (US)

(72) Inventors: Francesc Guim Bernat, Barcelona (ES); Karthik Kumar, Chandler, AZ (US); Akhilesh S. Thyagaturu, Ruskin, FL (US); Marcos Carranza, Portland, OR (US); Rajesh Poornachandran, Portland, OR (US)

(21) Appl. No.: 18/605,604

(22) Filed: Mar. 14, 2024

(51) Int. Cl. G06F 16/28; G06F 21/60

(52) U.S. Cl. CPC G06F 16/285; G06F 21/602

(57) ABSTRACT

Systems, apparatuses and methods include technology that identifies first data that is autonomously generated, where the first data is associated with a first source. The technology may further determine that the first data is to be marked with an indication that the first data is associated with the first source, generate an identifier associated with the first data based on the first data being determined to be marked, where the identifier indicates that the first data is associated with the first source, and store the identifier to an entry in a storage that is remotely accessible.

### BACKGROUND

Data may be generated by many different sources. For example, sensors may generate data. Video sensors may provide a video stream. Audio sensors may capture audio data. Other sensors and sources may also generate data. Machine learning models have the capacity to generate data as well.

### BRIEF DESCRIPTION OF THE DRAWINGS

The various advantages of the embodiments will become apparent to one skilled in the art by reading the following specification and appended claims, and by referencing the following drawings, in which:

FIG. 1 is an example of an authenticity and verification architecture according to an embodiment;

FIG. 2 is an example of a marking architecture according to an embodiment;

FIG. 3 is an example of a device owner marking architecture according to an embodiment;

FIG. 4 is an example of a non-fungible token generation architecture according to an embodiment;

FIG. 5 is an example of an activation architecture according to an embodiment;

FIG. 6 is a flowchart of an example of a method of generating identifying data according to an embodiment;

FIG. 7 is a diagram of an example of a computation enhanced computing system according to an embodiment;

FIG. 8 is an illustration of an example of a semiconductor apparatus according to an embodiment;

FIG. 9 is a block diagram of an example of a processor according to an embodiment; and

FIG. 10 is a block diagram of an example of a multi-processor based computing system according to an embodiment.

### DESCRIPTION OF EMBODIMENTS

There may be an ethical responsibility towards data creation and data consumption. As a consequence, there may be responsible actions that are adopted towards the data creation and consumption. Information validation in terms of accuracy and correctness is also a consideration to facilitate both responsible actions and fulfill the ethical responsibilities. To fulfill such responsibility and responsible actions, examples may automate data markup with a digital signature for data (e.g., generated content) that is identified as having certain characteristics. The digital signature may validate the data and link the data to a generation source that generated the data.

Data (e.g., content) may have varied applications. Some content may relate to information for entertainment, while other content may relate to life, safety, or mental wellbeing. By allowing data and information mark-up indicating a source (e.g., a creator that created the data and information, ownership information, etc.), along with a reasonable recommendation of a degree of data and information sensitivity, examples may provide responsible and ethical data generation and consumption.

Various generation sources may be responsible for generating data. Such sources may include different sensors, such as video sensors, audio sensors, proximity sensors, imaging sensors, etc. Some generation sources may include generative AI that generates artificially generated data.

Generative artificial intelligence (AI) is a type of AI that can create new content, such as text, images, music, audio, and videos. Generative AI has risen to the forefront of new content creation. New content creation may involve data and information that is consumed by consumers. Some consumers may presume such content to be a valid and authenticated form of information. The data and information may not be governed by anyone unless the publisher and/or owner provides an indication of the generation source of content.

Generative AI may be used in a variety of contexts and applications. For example, generative AI may generate human-like text, which is incorporated into chatbots, content generation, and language translation. Generative AI may generate realistic images, which have applications in art, design, and image synthesis. Generative AI may also generate music and audio. Generative AI may compose music or generate speech and sound effects for various media. Generative AI may augment data. Generative AI may generate synthetic data to augment training datasets, improving the performance of machine learning models. Generative AI may synthesize video. Generative AI may generate video content, including deepfake videos and video game animations. Other machine learning models may generate various data.

Generative AI raises ethical and creative considerations. For example, the use of generative AI raises ethical concerns, particularly regarding the generation of deepfake content, misinformation, and copyright issues. Additionally, generative AI has implications for creativity, as generative AI changes traditional notions of authorship/ownership as well as creativity.

Marking and maintaining the authenticity of such data (whether generated by generative AI or sensors) in existing technology may be sub-optimal for several technological reasons. Firstly, existing technologies lack a computing system that has the capability to automatically identify relevant data and mark the relevant data in a traceable fashion. Indeed, existing technology has no automated process that may automatically identify data that is suitable for marking and execute the marking on such data.

Secondly, the marking of data to link the data to generation sources provides unique technological considerations. For example, after data is released to the public, the data may be digitally modified to remove identifying information related to the generation source and compromise authenticity. In other situations, such identifying information may be altered to provide a false indication that the data was generated by a different source than the actual generation source. In some examples, the identifying information may be corrupted and loses viability to validate the data. Therefore, existing examples lack a technical mechanism to reliably link data to a generation source (e.g., content creator) in a tamper-proof way that remains constant, ensures authenticity and provides a level of guarantee of validity.

Examples remedy the aforementioned sub-optimal technological solutions. That is, examples include a process to verify and prove authenticity of a generation source (e.g., content creator) of data. To do so, examples identify first data that is autonomously generated, where the first data is associated with a first source; determine that the first data is to be marked with an indication that the first data is associated with the first source; generate an identifier associated with the first data based on the first data being determined to be marked, where the identifier indicates that the first data is associated with the first source; and store the identifier to an entry in a storage that is remotely accessible. Doing so enables generative AI and other data sources to generate information that may be automatically released to the public with confidence, accuracy and assuredness that the data is authentic. Furthermore, examples herein provide an enhanced technological solution that links data to the source even when the data is released to the public. That is, present examples of the enhanced process described herein include a mechanism to reliably link data to a generation source (e.g., content creator) in a tamper-proof way that remains constant, ensures authenticity and provides a level of guarantee of validity.

Further, examples as described herein deliver enhanced power efficiency and resource optimization by enabling advance notifications to host central processing units through dynamic management. Such fine-grained control of host CPU wake-up for nested Data Plane Development Kit (DPDK) applications improves both performance and power on General Purpose Compute (GPU).

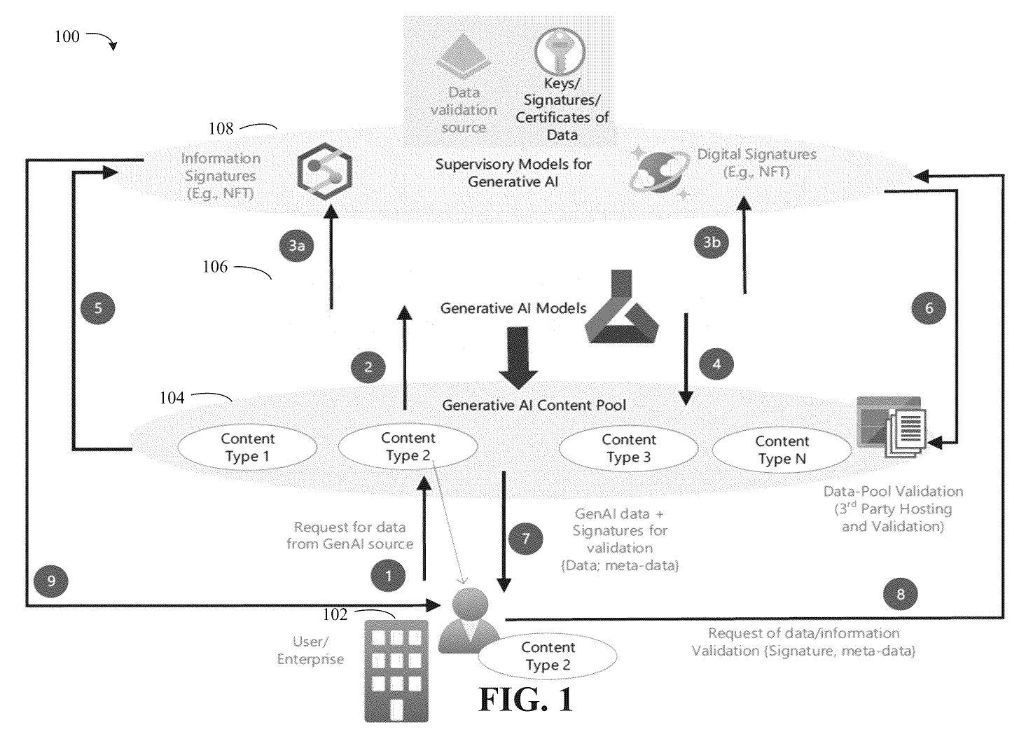

Turning now to FIG. 1, an overview of authenticity and verification architecture 100 is illustrated. Authenticity and verification architecture 100 may authenticate authorship and ownership of data. The data may be generated on a large-scale. Such large-scale examples may include content pools with licensing, copyright, authenticity, and accountability. The generative AI content pool 104 is one such example. The generative AI content pool 104 may be generated with generative AI models 106. In some examples, a sensor data pool (e.g., comprising sensor data generated by sensors) may be substituted for the generative AI content pool 104, and sensors may be substituted for the generative AI models 106.

Authenticity and verification architecture 100 may be particularly applied to large data-pool and/or content pools that comprises data generated in an automated fashion (e.g., data generated by generative AI and/or sensors). For example, the authenticity and verification architecture 100 may be able to seek ownership, as well as assume accountability for the content, information, and data that is being shared with others through the generative AI content pool 104.

In authenticity and verification architecture 100, a user and/or enterprise 102 may request data from the generative AI content pool 104. The generative AI content pool 104 may send the request for data to the generative AI models 106. In some examples, the generative AI content pool 104 may already include the data. In either scenario, the generative AI models 106 generates the data. The generative AI models 106 may generate the data, and in turn provide the data to the supervisory models for generative AI 108.

The supervisory models for generative AI 108 may validate and mark the data. Validation of the data may include identifying data that is acceptable to be provided to the generative AI content pool 104 and/or to be released to consumers. The supervisory models for generative AI 108 may also mark the data with authorship information associated with the generative AI models 106 (e.g., via an NFT representing ownership and/or authorship, and/or via a blockchain associated with the data) to generate validated data. For example, a private key may be associated with the data (e.g., stored with the data). The private key may not be a means to secure the validated data, but rather provide access to the authorship verification (e.g., stored in a blockchain). The private key may be used to verify the authorship of the validated data if a party so intends by decrypting meta-data of the NFT that indicates authorship information. Otherwise, the party may ignore the meta-data. NFT verification may be executed by exchanges, and at online locations that a producer and a consumer may agree upon. The supervisory models for generative AI 108 may provide the validated data to the generative AI content pool 104 in some examples.

NFTs have evolved with cryptocurrency in the recent past, accounting for billions in trading volume. Thus, the digital creation of tokens has experienced an upward trend. NFTs are unique crypto assets that are stored on a blockchain, and represent digital ownership of an event. NFTs span different domains to represent ownership. NFTs in existing technology may represent ownership over a digital asset but fail to represent the original generation source of the digital asset. Enhanced examples as described herein may leverage the powerful traceability and immutability of NFTs to authenticate data and mark the data with the source generation.

The process of creating an NFT may involve the following operations. The supervisory model for generative AI 108 may determine an asset (e.g., picture, a set of pictures, sensor readings, etc.) may have value and/or interest (e.g., meets an interest threshold based on signals of the data). The supervisory model for generative AI 108 may select blockchain technology to be used for the NFT creation (e.g., Ethereum, Solana, Flow, etc.). The supervisory model for generative AI 108 may create a digital wallet that supports a blockchain that stores the NFTs that are created, and which are accessed via a private key associated with the data. The private key may point to an NFT in the blockchain and decrypt the NFT. The supervisory model for generative AI 108 may then create the NFT. The generative AI 108 may include data validation sources and keys/signatures/certificates of data.

The output of the supervisory models for generative AI 108, such as the data validation (e.g., validated data) and NFTs, is stored into the generative AI content pool 104 (e.g., a data pool-validation that is third-party hosted and validated). In some examples, the output may include information signatures (e.g., information indicating the sensitivity of the data such as good, bad, neutral, or secure, non-secure, etc. t) and digital signatures (e.g., a digital signature similar to a fingerprinting of the data itself, which will be a unique identifier). The information signatures and digital signatures may be NFTs.

As noted, the enterprise 102 requests the validated data (e.g., generative AI data and signatures for validation that includes data and meta-data). The generative AI content pool 104 may provide the validated data to the enterprise 102. The enterprise 102 may verify the validated data by sending a message (e.g., comprising a request of data/information and signature for validation and meta-data) to the supervisory models for generative AI 108. The supervisory models for generative AI 108 may verify that the data/information is valid, and correct (e.g., the validated data is authored by the generative AI models 106 and other characteristics of the validated data such as maturity level ratings, etc.), and provide an indication of the validity and correctness of the valid data to the enterprise 102.

Thus, authenticity and verification architecture 100 may implement an accountability-as-a-service model. The authenticity and verification architecture 100 combines signatures (e.g., information and digital) with informational awareness through learning models, such as generative AI models 106, to derive an accountability model. Examples may be offered as a service to validate the source of data and information that is being used by the enterprise 102, and/or a user.

In some examples, the generative AI models 106 may be a Generative Pre-trained Transformer (GPT). The GPT may be an autonomous system that may be designed to continuously generate data (e.g., daily news generated by GenAI in fully autonomous way) with minimal to no human intervention.

Such a fully autonomous system may rely on credibility to be able to use and generate data with a level of trustworthiness. Such a level of trustworthiness may be facilitated by a trace back to the source of generation (e.g., the fully autonomous system). That is, the level of trustworthiness may be ensured by having the authorship and ownership.

The supervisory models for generative AI 108 may generate NFTs to trace data to the source of generation. As will be discussed below, the supervisory models for generative AI 108 may include AI-powered algorithms and/or systems that may independently generate, evaluate, and even sell digital assets generated by the generative AI models 106 (e.g., artwork, music, or other creative content, may be referred to as data). Such autonomous systems may be particularly applied to the areas of NFTs and digital art.

Some examples of the generative AI models 106 are as follows. In some examples, the supervisory models for generative AI 108 and generative AI content pool 104 may also facilitate the below examples.

The generative AI models 106 may include autonomous systems. Such autonomous systems often leverage advanced generative AI models like GPT or deep learning models specialized in image, music, or text generation. Some examples of the generative AI models 106 relate to content generation. These AI models may autonomously generate creative content such as digital art, music compositions, written stories, or even code. The content generated by these systems can be highly creative and unique.

Some examples of the generative AI models 106 and/or supervisory models for generative AI 108 include NFT Minting. Autonomous systems may be programmed to automatically mint NFTs for the content generated by the autonomous systems. Minting an NFT involves creating a unique token on a blockchain that represents a specific digital asset. Some examples of the generative AI models 106 include and/or supervisory models for generative AI 108 include metadata generation. The generative AI models 106 include and/or supervisory models for generative AI 108 may generate metadata for the NFT, which may include several fields comprising a title, description, and information about the generative AI models 106 and training data used to create the content.

In some examples, an autonomous system including the generative AI models 106 include, supervisory models for generative AI 108 and/or generative AI content pool 104, may automatically sell NFTs. The autonomous systems may list NFTs for sale on various NFT marketplaces without human intervention. Such autonomous systems may set prices, accept bids, and handle transactions. Some examples may also include ownership transfer. When someone purchases an NFT generated by the autonomous system, ownership of the associated content transfers to the buyer, and the blockchain associated with the NFT records the transaction.

Enhanced examples may therefore follow the same principle as blockchain. NFTs may attest to ownership as well as a source that generated data. Once NFT gets generated, the NFT is stored into blockchain logic.

The generative AI models 106 may be able to perform continuous content generation. For example, the generative AI models 106 may perform iterative creation. In such examples, the generative AI models 106 may continuously generate new content, and the supervisory models for generative AI 108 may create a stream of NFTs for sale, and track when the NFTs are sold. The supervisory models for generative AI 108 may identify first content that is selling at higher rates based on the NET sales, and second content that is selling at lower rates based on the NET sales. The supervisory models for generative AI 108 may instruct (e.g., provide message) the generative AI models 106 to generate content similar to the first content, and to reduce generation of content similar to the second content. For example, the first content may be categorized into a first category, and the generative AI models 106 may increase content generation that is categorized into the first category. That is, the generative AI models 106 may adapt a creative output of the generative AI models 106 based on various factors, including market demand or user preferences. In some examples, the generative AI models 106 may account for user feedback. The generative AI models 106 may generate content based on user feedback and preferences. Such a feedback loop of content generation, user feedback, further content generation based on the user feedback, further user feedback, etc. may enhance the quality and relevance of the generated content over time. Thus, the generative AI models 106 may adapt content generation strategies based on real-time data, market trends, and/or changing user tastes.

In some examples, the supervisory models for generative AI 108 and/or generative AI models 106 consider copyright and ownership. Autonomous systems raise questions about copyright and intellectual property rights, as well as issues related to authorship and attribution. Furthermore, the supervisory models for generative AI 108 may enforce content quality and responsibility. That is, the supervisory models for generative AI 108 ensures that the content generated by the generative AI models 106 is of high quality, ethical, and aligns with community standards is crucial.

In some examples, human feedback may guide the generative AI models 106 and/or the supervisory models for generative AI 108 as well. For example, while autonomous systems may handle many aspects of NFT creation and sales, human oversight may be added through rating, feedback, and a voting process for content, as well as to consider legal, ethical, and quality controls. Such enhanced technology may increase in relevance as autonomous systems are designed to learn and therefore have higher chances to generate and discover new data that may be suitable to be reclaimed via ownership, offer new data services, and operate in manner where large-scale data need not be moved physically (e.g., in the vehicular infrastructures, aircrafts, and other public transportation infrastructures).

The above are a few examples of digital media and specific applications of the supervisory models for generative AI 108, generative AI content pool 104 and generative AI content pool 104. The digital media may be “valuable” when converted into NFTs. Existing technology has no autonomous system to determine what subset of the rich digital data collected by infrastructures may be digitized into an NFT, and no capabilities in existing infrastructures are present to input user defined neural networks or other existing AI frameworks to analyze sensor data and decide on a perceived “value” using decision criteria including current events and/or news, and others, on data from individual sensors, and/or across multiple sensors, and/or over time. Enhanced examples as described herein have the capability to generate NFTs autonomously or semi-autonomously based on decision making and list them on marketplaces. Furthermore, enhanced examples as described herein may generate a closed loop feedback mechanisms between the decision criteria and the automatic generation of NFTs to reflect end user NFT trends.

Various forms of data may be marked as described above. For example, the generative AI models 106 may be replaced and/or augmented with sensors that determine various outputs. For example, an autonomous infrastructure equipped with different types of sensors and some measure of decision-making capability may be included in the authenticity and verification architecture 100. Such an infrastructure is capable of capturing a wide variety of sensor data. For example, such an infrastructure may include images spanning a variety of locations, some of which may include unique images (e.g., a specific incident, event, accident, images of historic relevance, images collected over time that may the evolution of how the landscape has changed, or visibility has reduced). Some examples may include sensor readings (e.g., CO₂ sensor readings that over time show how much pollution has impacted air quality over time in a location). Some examples may include digital statistics (e.g., showing a number of cars entering an abandoned town on a highway over time, statistics indicating how the town has been abandoned, etc.). The examples noted above may similarly be marked as described with respect to the supervisory models for generative AI 108.

Thus, examples herein include an autonomous system that executes an automatic data, content, and information, authorship, and ownership of large-scale data generation. Such large-scale data generation may include a content pool with licensing, copyright, authenticity, and accountability of automatically generated data (e.g., generative AI model host), which may be automatically and reliably validated. Examples may leverage automatic generation of NFTs to track, store, validate, and trace back the content and/or data to a source.

Doing so provides several enhancements. For example, there are multiple occurrences where NFT creation may be applied. As one particular example, there is growing interest on how to charge for information that third-parties (e.g., insurances) may use to perform their activities. Similarly, when research is being conducted in certain fields, having mechanisms to claim the ownership of certain data for authentication facilitates informed decisions generated on reliable information. Further, examples as described herein deliver enhanced power efficiency and resource optimization by enabling advance notifications to host central processing units through dynamic management. Such fine-grained control of host CPU wake-up for nested DPDK applications improves both performance and power on GPU.

It is worthwhile to note that the various components may be implemented in hardware circuitry and/or configurations. For example, the authenticity and verification architecture 100 may be implemented in hardware implementations that may include configurable logic, fixed-functionality logic, or any combination thereof. Examples of configurable logic include suitably configured programmable logic arrays (PLAs), field programmable gate arrays (FPGAs), complex programmable logic devices (CPLDs), and general purpose microprocessors. Examples of fixed-functionality logic include suitably configured application specific integrated circuits (ASICs), general purpose microprocessor or combinational logic circuits, and sequential logic circuits or any combination thereof. The configurable or fixed-functionality logic can be implemented with complementary metal oxide semiconductor (CMOS) logic circuits, transistor-transistor logic (TTL) logic circuits, or other circuits.

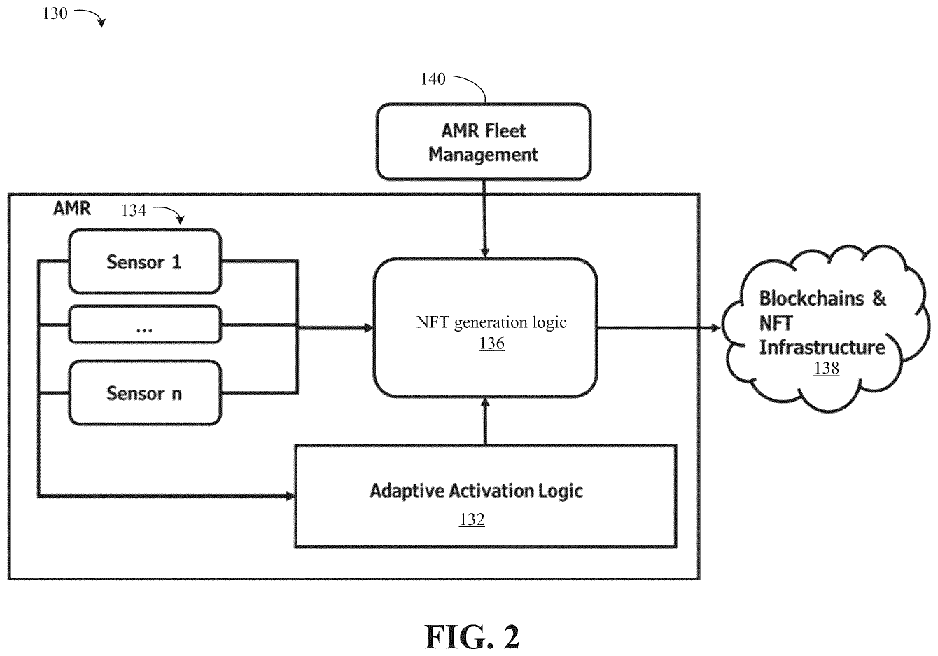

Turning now to FIG. 2, an exemplary marking architecture 130 is illustrated. Examples provide mechanisms that allow device owners to selectively create content ownership for one or multiple sensors (e.g., separately or aggregated) and/or other autonomously generated data. While examples describe NFT technology, it will be understood that other technologies may be used to mark data and trace ownership and/or authorship. In some examples, the exemplary marking architecture 130 may implement one or more aspects of the embodiments described herein. For example, the exemplary marking architecture 130 may implement one or more aspects of the authenticity and verification architecture 100 (FIG. 1), already discussed.

The exemplary marking architecture 130 permits device owners to register NFT activation functions that are stored as adaptive activation logic 132. Such functions, using one or more sensors as inputs, determine whether an NFT is to be generated for a set of sensors payloads from sensors 1-n 134. The adaptive activation logic 132 (e.g., activations functions) may operate with NFT generation logic 136. The NFT generation logic 136 marshals and creates final media based on the sensor payloads from sensors 1-n 134 that indicates the ownership and/or authorship. The NFT generation logic 136 may do so when the adaptive activation logic 132 identifies data that is to be marked. For example, the adaptive activation logic 132 may analyze the sensor payloads to determine whether the sensor payloads are suitable for release. If not, the adaptive activation logic 132 instructs the NFT generation logic 136 to not mark the sensor payload, and the sensor payload is abandoned and/or discarded. If the adaptive activation logic 132 determines that the sensor payload is suitable for release, the adaptive activation logic 132 instructs the NFT generation logic 136 to mark the sensor payload with authorship and/or ownership information as discussed above with respect to authenticity and verification architecture 100 (FIG. 1), for example by associating the data with an NFT that indicates the ownership and/or authorship.

For example, once the sensors 1-n 134 generate sensor payload (e.g., media), the adaptive activation logic 132 and NFT generation logic 136 may perform NFT inclusions into a selected blockchain using owner entity meta-data of the sensors 1-n 134 to do so. Once the NFT is added into the blockchain, the NFT itself is stored into a local NFT wallet that may be accessed out of band with the proper authentication keys. NFTs are encrypted with private keys from the owner and/or author inside a secure area (e.g., a Trusted Platform Module) to secure NFT generation. The adaptive activation logic 132 and/or the sensors 1-n 134 may be implemented in multiple places, starting from the sensors 1-n 134 down to a gateway aggregating the devices.

The NFT generation logic 136 is responsible for generating NFTs for the sensors 1-n 134, or a subset of selected sensors of the sensors 1-n 134, that are part of the NFT analysis and creation. The NFT generation logic 136 includes different interfaces to allow a device owner of the sensors 1-n 134 to setup an NFT wallet and required resources plus the logic to interact with the selected blockchain and NFT infrastructure 138.

Adaptive activation logic 132 is responsible for executing analytics models (e.g., machine learning models, neural networks, etc.) in an inline fashion to determine whether one or more sensor payloads are candidates for an NFT generation based on a certain criteria and/or metrics that may be programmed or automatically determined based on real-time factors (e.g., social media, posts, purchasing history, etc.).

In this example, the sensors 1-n 134 are part of an autonomous mobile robots (AMR) fleet. An AMR fleet management 140 may control the AMR fleet and the sensors 1-n 134.

It is worthwhile to note that the various components may be implemented in hardware circuitry and/or configurations. For example, the exemplary marking architecture 130 may be implemented in hardware implementations that may include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, general purpose microprocessor or combinational logic circuits, and sequential logic circuits or any combination thereof. The configurable or fixed-functionality logic can be implemented with CMOS logic circuits, TTL logic circuits, or other circuits.

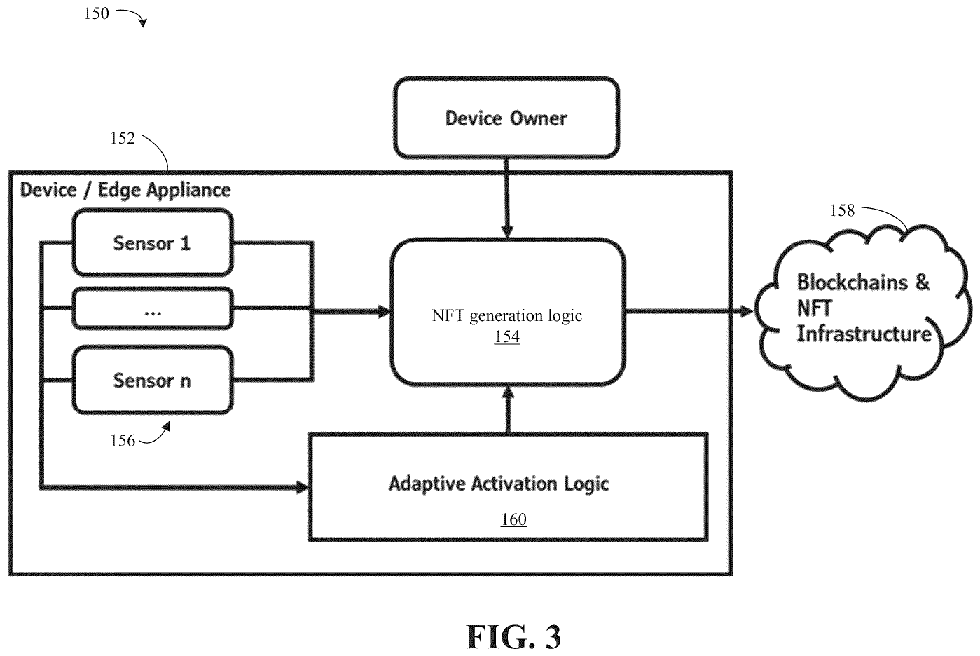

Turning now to FIG. 3, a device owner marking architecture 150 is illustrated. In some examples, the device owner marking architecture 150 may implement one or more aspects of the embodiments described herein. For example, the device owner marking architecture 150 may implement and/or be used in conjunction with one or more aspects of the examples described herein, for example, the authenticity and verification architecture 100 (FIG. 1) and/or exemplary marking architecture 130 (FIG. 2), already discussed.

The device owner marking architecture 150 may be implemented in device and/or edge appliance 152. The NFT generation logic 154 is responsible for generating NFTs for the sensors 1-n 156, or a subset of selected sensors of the sensors 1-n 156, that are part of the NFT analysis and creation. The NFT generation logic 154 includes different interfaces to allow a device owner of the sensors 1-n 156 to setup an NFT wallet and required resources plus the logic to interact with the selected blockchain and NFT infrastructure 158.

Adaptive activation logic 160 is responsible for executing analytics models (e.g., machine learning models, neural networks, etc.) in an inline fashion to determine whether one or more sensor payloads are candidates for an NFT generation based on a certain criteria and/or metrics that may be programmed or automatically determined based on real-time factors (e.g., social media, posts, purchasing history, etc.).

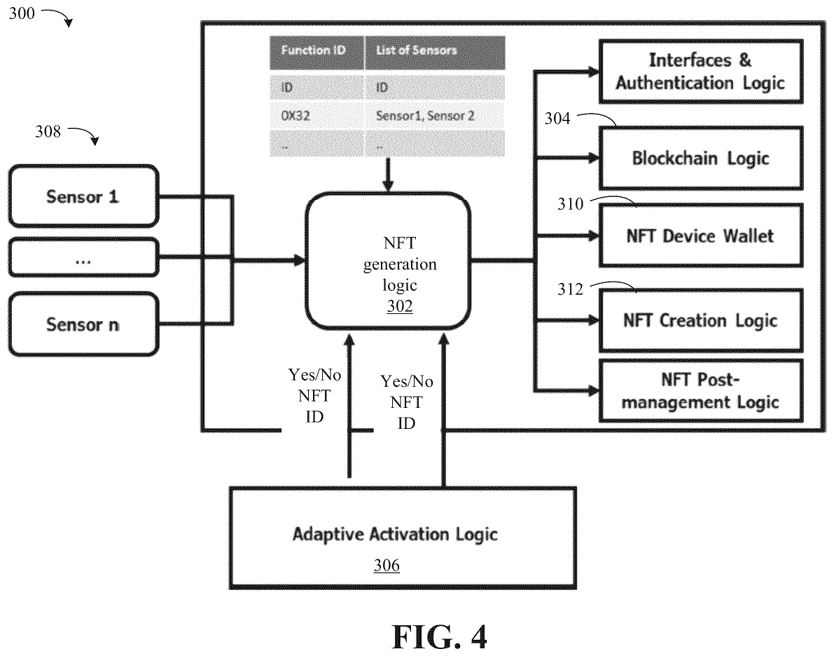

Turning now to FIG. 4, an NFT generation architecture 300 is illustrated in further detail. The NFT generation architecture 300 may generally be implemented with the embodiments described herein, for example, the authenticity and verification architecture 100 (FIG. 1), exemplary marking architecture 130 (FIG. 2), and/or device owner marking architecture 150 already discussed. More particularly, the NFT generation architecture 300 may be implemented in one or more modules as a set of logic instructions stored in a RAM, ROM, PROM, firmware, flash memory, etc., in hardware, or any combination thereof. For example, hardware implementations may include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, general purpose microprocessor or combinational logic circuits, and sequential logic circuits or any combination thereof. The configurable or fixed-functionality logic can be implemented with CMOS logic circuits, TTL logic circuits, or other circuits.

In this example, the NFT generation logic 302 is composed of several features. The NFT generation logic 302 may include a set of interfaces that allow a device owner to execute several actions. For example, the device owner may authenticate themselves to perform modifications on the configuration and/or criteria to generate an NFT. The device owner may also configure the credentials to generate and manage an NFT device wallet. Some examples may also configure various credentials to interact with a blockchain, which may be referred to as blockchain logic 304.

Examples may configure activation rules of activation functions for an NFT by adjusting activation criteria for adaptive activation logic 306. An activation rule of the adaptive activation logic 306 may be defined by the following elements: 1) a list of sensors that each provide an output to cause an activation to be triggered; and 2) a list of models (which may be neural networks or machine learning models) that are associated to each sensor and may be processed inline. If one or more of the sensors from the list of sensors fail to provide an output, the adaptive activation logic 306 will instruct the NFT generation logic 302 to avoid generation of an NFT based on data from other sensors of the sensors.

The NFT generation logic 302 may be a function that describes how data from different sensors may be combined to generate NFT media. The NFT media may be signed. Examples may configure the various models that are used as part of the activation rules. Each of these models are defined by model identification and a binary associated to the model.

The NFT generation logic 302 controls different modules to generate an NFT. NFT creation logic 312 is responsible for creating the NFT. The NFT creation logic 312 may be configured to have a set of NFT networks that each individually operate over different sets of sensor data. The NFT creation logic 312 may interact with an NFT device wallet 310 to obtain the credentials to create the NFT. When the adaptive activation logic 306 indicates that an NFT is to be generated for a certain list of sensors, a submodule of the NFT creation logic 312 may perform several actions. For example, the NFT creation logic 312 may gather all sensor payloads of sensors 1-n 308 that correspond to the NFT activation rule (e.g., have sensor payloads that are to be associated together according to a rule). The NFT creation logic 312 may execute a binary and/or formula that generates media (e.g., includes the sensor payloads) that will be the NFT based on the sensor payloads. The resulting NFT creation logic 312 interacts with an NFT network to create the NFT itself based on the media. The NFT creation logic 312 may add the NFT to a blockchain network with blockchain logic 304.

The blockchain logic 304 is responsible for interacting with the blockchain network to perform several actions. The blockchain logic 304 may be configured to have a set of blockchain networks. The blockchain logic 304 will interact with the NFT creation logic 312 when an NFT is generated and is to be added automatically to the blockchain network.

An NFT device wallet 310 stores all the various logic to store the device owner logic. The NFT device wallet 310 allows configuration of credentials on behalf of the owner. The NFT device wallet 310 enables retrieval of generated NFTs with the proper credentials. NFTs are generated within a private and secure enclave to protect generated NFTs.

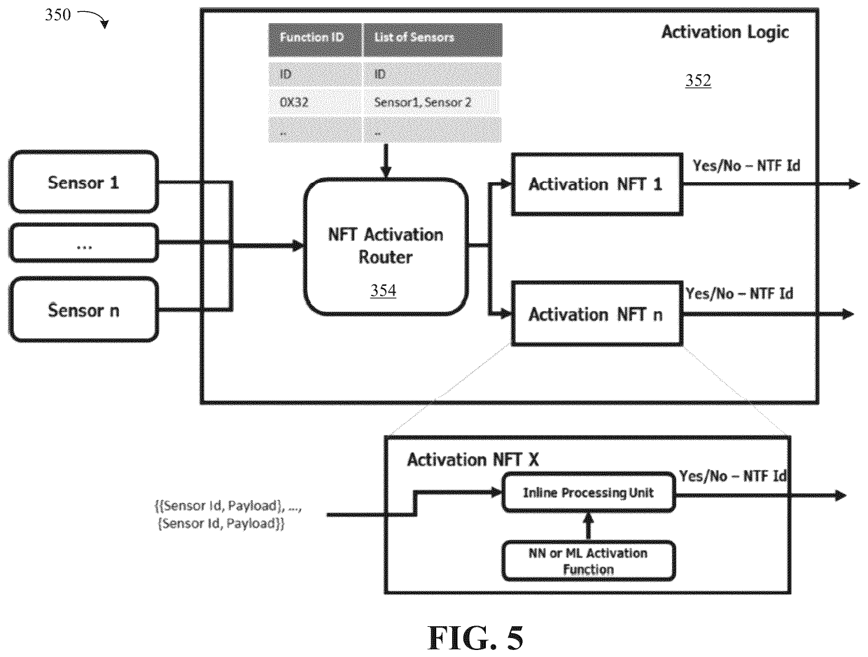

Turning now to FIG. 5, an activation architecture 350 is illustrated in further detail. The activation architecture 350 may generally be implemented with the embodiments described herein, for example, the authenticity and verification architecture 100 (FIG. 1), exemplary marking architecture 130 (FIG. 2), architecture 150 (FIG. 3), and/or NFT generation architecture 300 (FIG. 4) already discussed. More particularly, the activation architecture 350 may be implemented in one or more modules as a set of logic instructions stored in a RAM, ROM, PROM, firmware, flash memory, etc., in hardware, or any combination thereof. For example, hardware implementations may include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, general purpose microprocessor or combinational logic circuits, and sequential logic circuits or any combination thereof. The configurable or fixed-functionality logic can be implemented with CMOS logic circuits, TTL logic circuits, or other circuits.

The activation logic 352 is composed of several features. The activation logic 352 includes an NFT activation router 354. The activation logic 352 describes each activation by a list of inputs sensors that define a potential NFT, a list of activation functions that process the sensor data. Every clock that the sensors generate the payload (assuming that the sensors will generate data sets within a certain amount of time and are therefore considered atomic), per each activation the activation logic 352 may identify all the sensors associated to NFT generated data. If less than all sensors for the NFT generated data provide sensor data, nothing further is performed. If all the sensors associated with the NFT generated data provide sensor data, the activation logic 352 will route each of the sensors to the corresponding activation function.

The activation functions are responsible for processing inline data coming from the NFT activation router. Each activation function may operate differently and is constituted by a set of inline processing units that may include either a processor or an accelerator to process the data in an inline fashion. The activation function may also include a neural network or a machine learning model that will be executed for the sensor payloads. The activation function, on a new payload may receive as input the sensor payload, execute the function by providing the payload as input, and provide the results to the NFT Activation router 354 again with several notifications. The first notification may be a result of the activation function (e.g., yes or no). The second notification may be a corresponding sensor ID that provided the data. A third notification may be the NFT Rule ID (optionally depending on the implementation)

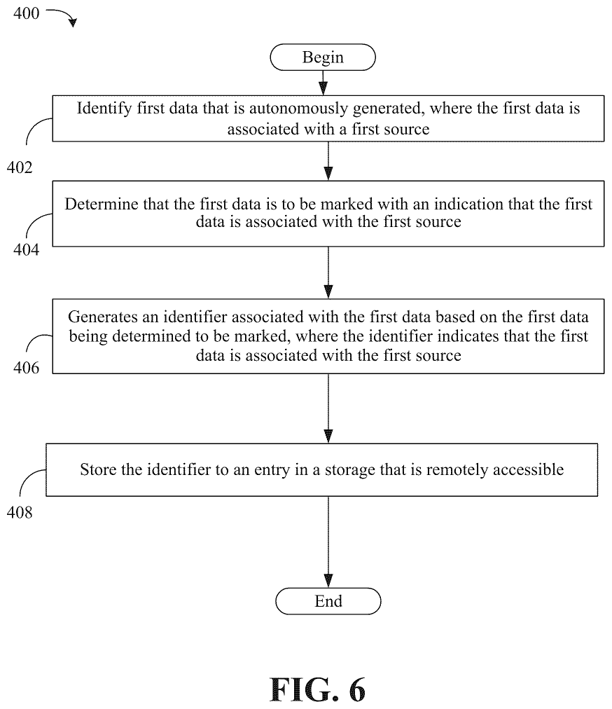

Turning now to FIG. 6, a method 400 of generating identifying data is illustrated in further detail. The method 400 may generally be implemented with the embodiments described herein, for example, the may generally be implemented with the embodiments described herein, for example, the authenticity and verification architecture 100 (FIG. 1), exemplary marking architecture 130 (FIG. 2), architecture 150 (FIG. 3), NFT generation architecture 300 (FIG. 4) and/or activation architecture 350 (FIG. 5) already described. More particularly, the NFT generation architecture 300 may be implemented in one or more modules as a set of logic instructions stored in a RAM, ROM, PROM, firmware, flash memory, etc., in hardware, or any combination thereof. For example, hardware implementations may include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, general purpose microprocessor or combinational logic circuits, and sequential logic circuits or any combination thereof. The configurable or fixed-functionality logic can be implemented with CMOS logic circuits, TTL logic circuits, or other circuits.

For example, computer program code to carry out operations shown in the device owner marking method 400 may be written in any combination of one or more programming languages, including an object-oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 402 identifies first data that is autonomously generated, where the first data is associated with a first source. Illustrated processing block 404 determines that the first data is to be marked with an indication that the first data is associated with the first source. Illustrated processing block 406 generates an identifier associated with the first data based on the first data being determined to be marked, where the identifier indicates that the first data is associated with the first source. Illustrated processing block 408 stores the identifier to an entry in a storage that is remotely accessible.

In some examples, the method 400 includes identifying second data, determining that the second data is to by bypassed for association with the first source and discards the second data to bypass generation of a second identifier based on the second data being determined to be bypassed for association with the first source. In such examples, the method 400 includes a first sensor that is to generate the first data, the first sensor being associated with a first activation function, a second sensor that is to generate the second data, where the second sensor is associated with a second activation function, where the second activation function is different from the first activation function, where to determine that the first data is to be marked with the indication the method 400 includes executing the first activation function, and determining that the second data is to by bypassed for association with the first source includes executing the second activation function.

In some examples, the method 400 includes determining input sensors associated with a first activation function, identifying that the first data is generated by the input sensors, and routing the first data to the first activation function based on the first data being generated by the input sensors, where the determining that the first data is to be marked with the indication includes executing the first activation function. In such examples, the first activation function comprises a machine learning model.

In some examples, the method 400 includes encrypting the identifier with a private key associated with the first source. In some examples, the identifier represents one or more of ownership of the first data by the first source, a sensor of the first source that generated the first data or a machine learning model of the first source that generated the first data.

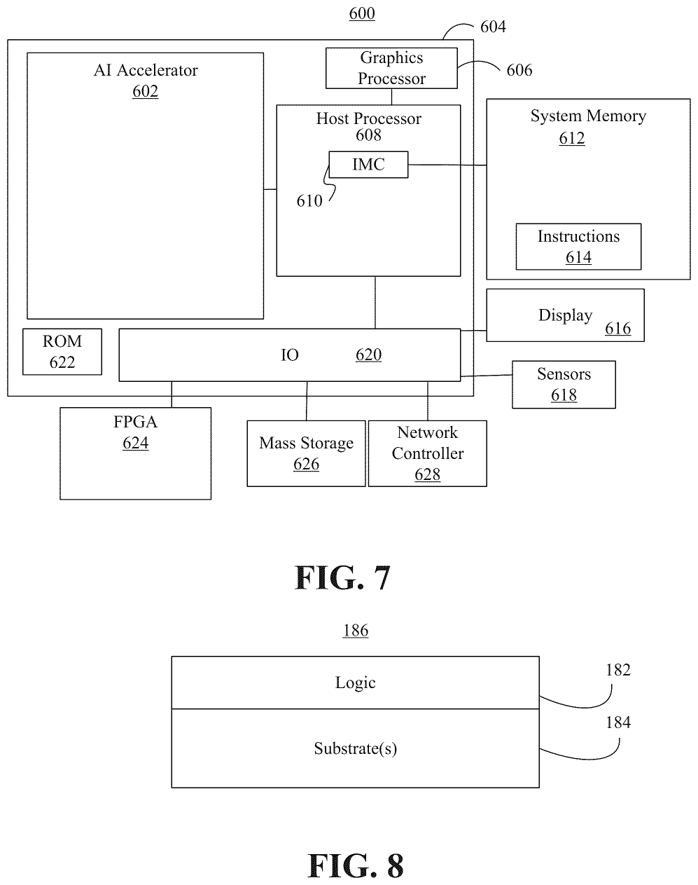

Turning now to FIG. 7, an enhanced tracking computing system 600 is shown. The computation enhanced computing system 600 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot, manufacturing robot, autonomous vehicle, industrial robot, etc.), edge device (e.g., mobile phone, desktop, etc.) etc., or any combination thereof. In the illustrated example, the computing system 600 includes a host processor 608 (e.g., CPU) having an integrated memory controller (IMC) 610 that is coupled to a system memory 612.

The illustrated computing system 600 also includes an input output (IO) module 620 implemented together with the host processor 608, the graphics processor 606 (e.g., GPU), ROM 622, and AI accelerator 602 on a semiconductor die 604 as a system on chip (SoC). The illustrated IO module 620 communicates with, for example, a display 616 (e.g., touch screen, liquid crystal display/LCD, light emitting diode/LED display), a network controller 628 (e.g., wired and/or wireless), FPGA 624 and mass storage 626 (e.g., hard disk drive/HDD, optical disk, solid state drive/SSD, flash memory). The IO module 620 also communicates with sensors 618 (e.g., video sensors, audio sensors, proximity sensors, heat sensors, etc.).

The SoC 604 may further include processors (not shown) and/or the AI accelerator 602 dedicated to artificial intelligence (AI) and/or neural network (NN) processing. For example, the SoC 604 may include vision processing units (VPUs) and/or other AI/NN-specific processors such as the AI accelerator 602, etc. In some embodiments, any aspect of the embodiments described herein may be implemented in the processors, such as the graphics processor 606 and/or the host processor 608, and in the accelerators dedicated to AI and/or NN processing such as AI accelerator 602 or other devices such as the FPGA 624. In this particular example, the AI accelerator 602 may execute activation functions and/or linking of content to author and/or owner of the content.

The graphics processor 606, AI accelerator 602 and/or the host processor 608 may execute instructions 614 retrieved from the system memory 612 (e.g., a dynamic random-access memory) and/or the mass storage 626 to implement aspects as described herein. In some examples, when the instructions 614 are executed, the computing system 600 may implement one or more aspects of the embodiments described herein. For example, the computing system 600 may implement one or more aspects of the examples described herein, for example, the activation architecture 350 is illustrated in further detail. The activation architecture 350 may generally be implemented with the embodiments described herein, for example, the authenticity and verification architecture 100 (FIG. 1), exemplary marking architecture 130 (FIG. 2), architecture 150 (FIG. 3), NFT generation architecture 300 (FIG. 4), activation architecture 350 (FIG. 5) and/or method 400 (FIG. 6) already discussed. The illustrated computing system 600 is therefore considered to be memory and performance-enhanced at least to the extent that the computing system 600 may execute machine learning operations.

FIG. 8 shows a semiconductor apparatus 186 (e.g., chip, die, package). The illustrated apparatus 186 includes one or more substrates 184 (e.g., silicon, sapphire, gallium arsenide) and logic 182 (e.g., transistor array and other integrated circuit/IC components) coupled to the substrate(s) 184. In an embodiment, the apparatus 186 is operated in an application development stage and the logic 182 performs one or more aspects of the embodiments described herein. For example, the authenticity and verification architecture 100 (FIG. 1), exemplary marking architecture 130 (FIG. 2), architecture 150 (FIG. 3), NFT generation architecture 300 (FIG. 4), activation architecture 350 (FIG. 5) and/or method 400 (FIG. 6) already discussed. The logic 182 may be implemented at least partly in configurable logic or fixed-functionality hardware logic. In one example, the logic 182 includes transistor channel regions that are positioned (e.g., embedded) within the substrate(s) 184. Thus, the interface between the logic 182 and the substrate(s) 184 may not be an abrupt junction. The logic 182 may also be considered to include an epitaxial layer that is grown on an initial wafer of the substrate(s) 184.

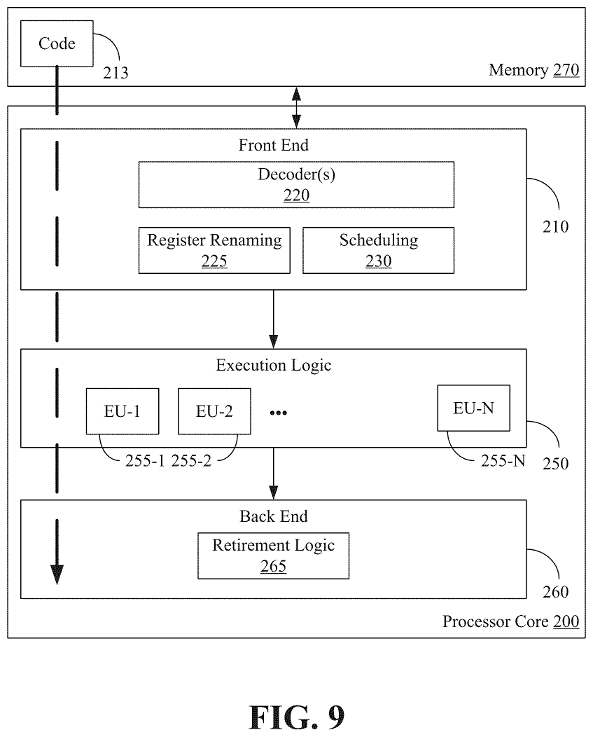

FIG. 9 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 9, a processing element may alternatively include more than one of the processor core 200 illustrated in FIG. 9. The processor core 200 may be a single-threaded core or, for at least one embodiment, the processor core 200 may be multithreaded in that it may include more than one hardware thread context (or “logical processor”) per core.

FIG. 9 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement one or more aspects of the embodiments such as, for example, the authenticity and verification architecture 100 (FIG. 1), exemplary marking architecture 130 (FIG. 2), architecture 150 (FIG. 3), NFT generation architecture 300 (FIG. 4), activation architecture 350 (FIG. 5) and/or method 400 (FIG. 6) already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include several execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 9, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

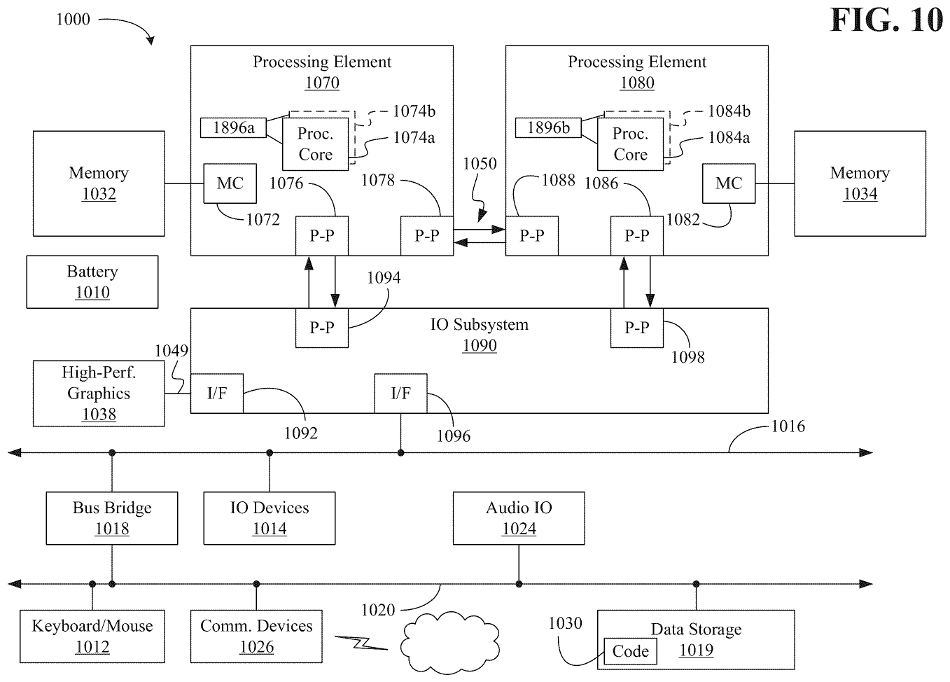

Referring now to FIG. 10, shown is a block diagram of a computing system 1000 embodiment in accordance with an embodiment. Shown in FIG. 10 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood any or all the interconnects illustrated in FIG. 10 may be implemented as a multi-drop bus rather than point-to-point interconnect.

As shown in FIG. 10, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner like that discussed above in connection with FIG. 9.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments is not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 10, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 10, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments is not so limited.

As shown in FIG. 10, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the one or more aspects of such as, for example, the authenticity and verification architecture 100 (FIG. 1), exemplary marking architecture 130 (FIG. 2), architecture 150 (FIG. 3), NFT generation architecture 300 (FIG. 4), activation architecture 350 (FIG. 5) and/or method 400 (FIG. 6) already discussed. Further, an audio I/O 1024 may be coupled to second bus 1020 and a battery 1010 may supply power to the computing system 1000.

Note that other embodiments are contemplated. For example, instead of the point-to-point architecture of FIG. 10, a system may implement a multi-drop bus or another such communication topology. Also, the elements of FIG. 10 may alternatively be partitioned using more or fewer integrated chips than shown in FIG. 10.

### Additional Notes and Examples:

Example 1 includes a computing system comprising a processor, and a memory having a set of instructions, which when executed by the processor, cause the computing system to identify first data that is autonomously generated, where the first data is associated with a first source, determine that the first data is to be marked with an indication that the first data is associated with the first source, generate an identifier associated with the first data based on the first data being determined to be marked, where the identifier indicates that the first data is associated with the first source, and store the identifier to an entry in a storage that is remotely accessible.

Example 2 includes the computing system of example 1, where the set of instructions, which when executed by the processor, cause the computing system to identify second data, determine that the second data is to be bypassed for association with the first source, and discard the second data based on the second data being determined to be bypassed for association with the first source.

Example 3 includes the computing system of example 2, further comprising a first sensor that is to generate the first data, where the first sensor is associated with a first activation function, a second sensor that is to generate the second data, where the second sensor is associated with a second activation function, where the second activation function is different from the first activation function, and where to determine that the first data is to be marked with the indication, the set of instructions, which when executed by the processor, cause the computing system to execute the first activation function, and where to determine that the second data is to be bypassed for association with the first source, the set of instructions, which when executed by the processor, cause the computing system to execute the second activation function.

Example 4 includes the computing system of example 1, where the set of instructions, which when executed by the processor, cause the computing system to determine input sensors associated with a first activation function, identify that the first data is generated by the input sensors, and route the first data to the first activation function based on the first data being generated by the input sensors, where to determine that the first data is to be marked with the indication, the set of instructions, which when executed by the processor, cause the computing system to execute the first activation function.

Example 5 includes the computing system of example 4, where the first activation function comprises a machine learning model.

Example 6 includes the computing system of example 1, where the set of instructions, which when executed by the processor, cause the computing system to encrypt the identifier with a private key associated with the first source, where the private key identifies the entry, and associate the private key with the first data.

Example 7 includes the computing system of any one of examples 1 to 6, where the identifier represents one or more of ownership of the first data by the first source, a sensor of the first source that generated the first data or a machine learning model of the first source that generated the first data.

Example 8 includes a semiconductor apparatus comprising one or more substrates, and logic coupled to the one or more substrates, where the logic is implemented at least partly in one or more of configurable logic or fixed-functionality hardware logic, the logic coupled to the one or more substrates to identify first data that is autonomously generated, where the first data is associated with a first source, determine that the first data is to be marked with an indication that the first data is associated with the first source, generate an identifier associated with the first data based on the first data being determined to be marked, where the identifier indicates that the first data is associated with the first source, and store the identifier to an entry in a storage that is remotely accessible.

Example 9 includes the apparatus of example 8, where the logic coupled to the one or more substrates is to identify second data, determine that the second data is to be bypassed for association with the first source, and discard the second data based on the second data being determined to be bypassed for association with the first source.

Example 10 includes the apparatus of example 9, where the logic coupled to the one or more substrates is to determine that a first sensor generated the first data, where the first sensor is associated with a first activation function, and determine that a second sensor generated the second data, where the second sensor is associated with a second activation function, where the second activation function is different from the first activation function, where to determine that the first data is to be marked with the indication, the logic coupled to the one or more substrates is to execute the first activation function, and where to determine that the second data is to be bypassed for association with the first source, the logic coupled to the one or more substrates is to execute the second activation function.

Example 11 includes the apparatus of example 8, where the logic coupled to the one or more substrates is to determine input sensors associated with a first activation function, identify that the first data is generated by the input sensors, and route the first data to the first activation function based on the first data being generated by the input sensors, where to determine that the first data is to be marked with the indication, the logic coupled to the one or more substrates is to execute the first activation function.

Example 12 includes the apparatus of example 11, where the first activation function comprises a machine learning model.

Example 13 includes the apparatus of example 8, where the logic coupled to the one or more substrates is to encrypt the identifier with a private key associated with the first source, where the private key identifies the entry, and associate the private key with the first data.

Example 14 includes the apparatus of any one of examples 8 to 13, where the identifier represents one or more of ownership of the first data by the first source, a sensor of the first source that generated the first data or a machine learning model of the first source that generated the first data.

Example 15 includes the apparatus of any one of examples 8 to 13, where the logic coupled to the one or more substrates includes transistor channel regions that are positioned within the one or more substrates.

Example 16 includes at least one non-transitory computer readable storage medium comprising a set of executable program instructions, which when executed by a computing system, cause the computing system to identify first data that is autonomously generated, where the first data is associated with a first source, determine that the first data is to be marked with an indication that the first data is associated with the first source, generate an identifier associated with the first data based on the first data being determined to be marked, where the identifier indicates that the first data is associated with the first source, and store the identifier to an entry in a storage that is remotely accessible.

Example 17 includes the at least one non-transitory computer readable storage medium of example 16, where the instructions, when executed, cause the computing system to identify second data, determine that the second data is to be bypassed for association with the first source, and discard the second data based on the second data being determined to be bypassed for association with the first source.

Example 18 includes the at least one non-transitory computer readable storage medium of example 17, where the instructions, when executed, cause the computing system to determine that a first sensor generated the first data, where the first sensor is associated with a first activation function, and determine that a second sensor generated the second data, where the second sensor is associated with a second activation function, where the second activation function is different from the first activation function, where to determine that the first data is to be marked with the indication, the instructions, when executed, cause the computing system to execute the first activation function, and where to determine that the second data is to be bypassed for association with the instructions, when executed, cause the computing system to execute the second activation function.

Example 19 includes the at least one non-transitory computer readable storage medium of example 16, where the instructions, when executed, cause the computing system to determine input sensors associated with a first activation function, identify that the first data is generated by the input sensors, and route the first data to the first activation function based on the first data being generated by the input sensors, where to determine that the first data is to be marked with the indication, the instructions, when executed, cause the computing system to execute the first activation function, and where the first activation function comprises a machine learning model.

Example 20 includes the at least one non-transitory computer readable storage medium of any one of examples 16 to 19, where the instructions, when executed, cause the computing system to encrypt the identifier with a private key associated with the first source, where the private key identifies the entry, and associate the private key with the first data, where the identifier represents one or more of ownership of the first data by the first source, a sensor of the first source that generated the first data or a machine learning model of the first source that generated the first data.

Example 21 includes a semiconductor apparatus comprising means for identifying first data that is autonomously generated, where the first data is associated with a first source, means for determining that the first data is to be marked with an indication that the first data is associated with the first source, means for generating an identifier associated with the first data based on the first data being determined to be marked, where the identifier indicates that the first data is associated with the first source, and means for storing the identifier to an entry in a storage that is remotely accessible.

Example 22 includes the apparatus of example 21, further comprising means for identifying second data, means for determining that the second data is to be bypassed for association with the first source, and means for discarding the second data based on the second data being determined to be bypassed for association with the first source.

Example 23 includes the apparatus of example 22, further comprising means for determining that a first sensor generated the first data, where the first sensor is associated with a first activation function, and means for determining that a second sensor generated the second data, where the second sensor is associated with a second activation function, where the second activation function is different from the first activation function, where the means for determining that the first data is to be marked with the indication includes a means for executing the first activation function, and where the means for determining that the second data is bypassed for association with the first source includes a means for executing the second activation function.

Example 24 includes the apparatus of example 21, where further comprising means for determining input sensors associated with a first activation function, means for identifying that the first data is generated by the input sensors, and means for routing the first data to the first activation function based on the first data being generated by the input sensors, where the means for determining that the first data is to be marked with the indication, includes a means for executing the first activation function.

Example 25 includes the apparatus of example 21, where the first activation function comprises a machine learning model.

Example 26 includes the apparatus of example 21, further comprising means for encrypting the identifier with a private key associated with the first source, where the private key identifies the entry, and means for associating the private key with the first data.

Example 27 includes the apparatus of any one of examples 21 to 26, where the identifier represents one or more of ownership of the first data by the first source, a sensor of the first source that generated the first data or a machine learning model of the first source that generated the first data.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical, or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a processor; and
a memory having a set of instructions, which when executed by the processor, cause the computing system to:
identify first data that is autonomously generated, wherein the first data is associated with a first source;
determine that the first data is to be marked with an indication that the first data is associated with the first source;
generate an identifier associated with the first data based on the first data being determined to be marked, wherein the identifier indicates that the first data is associated with the first source; and
store the identifier to an entry in a storage that is remotely accessible.

2. The computing system of claim 1, wherein the set of instructions, which when executed by the processor, cause the computing system to:
identify second data;
determine that the second data is to be bypassed for association with the first source; and
discard the second data based on the second data being determined to be bypassed for association with the first source.

3. The computing system of claim 2, further comprising:
a first sensor that is to generate the first data, wherein the first sensor is associated with a first activation function;
a second sensor that is to generate the second data, wherein the second sensor is associated with a second activation function, wherein the second activation function is different from the first activation function; and
wherein to determine that the first data is to be marked with the indication, the set of instructions, which when executed by the processor, cause the computing system to execute the first activation function; and
wherein to determine that the second data is to be bypassed for association with the first source, the set of instructions, which when executed by the processor, cause the computing system to execute the second activation function.

4. The computing system of claim 1, wherein the set of instructions, which when executed by the processor, cause the computing system to:
determine input sensors associated with a first activation function;
identify that the first data is generated by the input sensors; and
route the first data to the first activation function based on the first data being generated by the input sensors;
wherein to determine that the first data is to be marked with the indication, the set of instructions, which when executed by the processor, cause the computing system to execute the first activation function.

5. The computing system of claim 4, wherein the first activation function comprises a machine learning model.

6. The computing system of claim 1, wherein the set of instructions, which when executed by the processor, cause the computing system to:
encrypt the identifier with a private key associated with the first source, wherein the private key identifies the entry; and
associate the private key with the first data.

7. The computing system of claim 1, wherein the identifier represents one or more of ownership of the first data by the first source, a sensor of the first source that generated the first data or a machine learning model of the first source that generated the first data.

8. A semiconductor apparatus comprising:
one or more substrates; and
logic coupled to the one or more substrates, wherein the logic is implemented at least partly in one or more of configurable logic or fixed-functionality hardware logic, the logic coupled to the one or more substrates to:
identify first data that is autonomously generated, wherein the first data is associated with a first source;
determine that the first data is to be marked with an indication that the first data is associated with the first source;
generate an identifier associated with the first data based on the first data being determined to be marked, wherein the identifier indicates that the first data is associated with the first source; and
store the identifier to an entry in a storage that is remotely accessible.

9. The apparatus of claim 8, wherein the logic coupled to the one or more substrates is to:
identify second data;
determine that the second data is to be bypassed for association with the first source; and
discard the second data based on the second data being determined to be bypassed for association with the first source.

10. The apparatus of claim 9, wherein the logic coupled to the one or more substrates is to:
determine that a first sensor generated the first data, wherein the first sensor is associated with a first activation function; and
determine that a second sensor generated the second data, wherein the second sensor is associated with a second activation function, wherein the second activation function is different from the first activation function;
wherein to determine that the first data is to be marked with the indication, the logic coupled to the one or more substrates is to execute the first activation function; and
wherein to determine that the second data is to be bypassed for association with the first source, the logic coupled to the one or more substrates is to execute the second activation function.

11. The apparatus of claim 8, wherein the logic coupled to the one or more substrates is to:
determine input sensors associated with a first activation function;
identify that the first data is generated by the input sensors; and
route the first data to the first activation function based on the first data being generated by the input sensors;
wherein to determine that the first data is to be marked with the indication, the logic coupled to the one or more substrates is to execute the first activation function.

12. The apparatus of claim 11, wherein the first activation function comprises a machine learning model.

13. The apparatus of claim 8, wherein the logic coupled to the one or more substrates is to:
encrypt the identifier with a private key associated with the first source, wherein the private key identifies the entry; and
associate the private key with the first data.

14. The apparatus of claim 8, wherein the identifier represents one or more of ownership of the first data by the first source, a sensor of the first source that generated the first data or a machine learning model of the first source that generated the first data.

15. The apparatus of claim 8, wherein the logic coupled to the one or more substrates includes transistor channel regions that are positioned within the one or more substrates.

16. At least one non-transitory computer readable storage medium comprising a set of executable program instructions, which when executed by a computing system, cause the computing system to:
identify first data that is autonomously generated, wherein the first data is associated with a first source;
determine that the first data is to be marked with an indication that the first data is associated with the first source;
generate an identifier associated with the first data based on the first data being determined to be marked, wherein the identifier indicates that the first data is associated with the first source; and
store the identifier to an entry in a storage that is remotely accessible.

17. The at least one non-transitory computer readable storage medium of claim 16, wherein the instructions, when executed, cause the computing system to:
identify second data;
determine that the second data is to be bypassed for association with the first source; and
discard the second data based on the second data being determined to be bypassed for association with the first source.

18. The at least one non-transitory computer readable storage medium of claim 17, wherein the instructions, when executed, cause the computing system to:
determine that a first sensor generated the first data, wherein the first sensor is associated with a first activation function; and
determine that a second sensor generated the second data, wherein the second sensor is associated with a second activation function, wherein the second activation function is different from the first activation function;
wherein to determine that the first data is to be marked with the indication, the instructions, when executed, cause the computing system to execute the first activation function; and
wherein to determine that the second data is to be bypassed for association with the instructions, when executed, cause the computing system to execute the second activation function.

19. The at least one non-transitory computer readable storage medium of claim 16, wherein the instructions, when executed, cause the computing system to:
determine input sensors associated with a first activation function;
identify that the first data is generated by the input sensors; and
route the first data to the first activation function based on the first data being generated by the input sensors;
wherein to determine that the first data is to be marked with the indication, the instructions, when executed, cause the computing system to execute the first activation function; and
wherein the first activation function comprises a machine learning model.

20. The at least one non-transitory computer readable storage medium of claim 16, wherein the instructions, when executed, cause the computing system to:
encrypt the identifier with a private key associated with the first source, wherein the private key identifies the entry; and
associate the private key with the first data,
wherein the identifier represents one or more of ownership of the first data by the first source, a sensor of the first source that generated the first data or a machine learning model of the first source that generated the first data.
